(19) United States
(12) Patent Application Publication
(10) Pub. No.: US 2013/0303265 A1
(43) Pub. Date: Nov. 14, 2013

(54) GAMING MACHINES AND SYSTEMS HAVING PERSISTENT SECONDARY GAMES

(71) Applicants: Cameron A. FILIPOUR, Las Vegas, NV (US); Mark S. ROSS, Las Vegas, NV (US)

(72) Inventors: Kevan WILKINS, Las Vegas, NV (US); Cameron A. FILIPOUR, Las Vegas, NV (US); Mark S. ROSS, Las Vegas, NV (US)

(73) Assignee: IGT, Reno, NV (US)

(21) Appl. No.: 13/471,157

(22) Filed: May 14, 2012

(51) Int. Cl. A63F 13/10; A63F 13/12; A63F 13/00

(52) U.S. Cl. 463/25; 463/20; 463/42

(57) ABSTRACT

A processor-based gaming machine or system running traditional wager-based primary games includes a secondary game component that provides a secondary game associated with the primary games. The secondary game includes persisting credits having a monetary value that remain across the play of multiple discrete primary games. The persisting credits can be cashed out by a player at any time, and have a value that can rise, fall, or remain constant based on the play of each discrete primary game. The secondary game can involve a themed game where players develop and maintain virtual entities and/or vanity items or statuses. Persisting credits and vanity items can persist across multiple primary game plays and separate gaming sessions, and may be available on separate social gaming venues. Systems can include a remote server that administers the secondary game and a database that stores player profiles for customized secondary game progressions.

### TECHNICAL FIELD

The present invention relates generally to gaming machines and systems, and more particularly to game types that can be played on such gaming machines.

### BACKGROUND

As technology in the gaming industry progresses, the traditional mechanically driven reel slot machines are being replaced by electronic machines having an LCD video display or the like. Processor-based gaming machines are now the norm. One reason for their increased popularity is the nearly endless variety of games that can be implemented using processor-based technology. Such processor-based gaming machines permit the use of advanced player tracking, improved security, and wireless communications, and also add a host of digital features that are not be possible on mechanical-driven gaming machines. In addition, the use of processor-based machines having video displays has resulted in the ability to provide more complex, attractive and exciting games to players. Such recent advances have proven to be useful in the evolution of gaming machines

Much of the enduring success of craps and other similar table games can be attributable to a compounding bet dynamic where players can leave wagers in play over multiple games, let winnings “ride” if desired, and enjoy wins that can grow exponentially during a hot streak. Such a gaming dynamic is generally characterized in that overall suspense can be built by not providing a wager outcome on every gaming play (e.g., a roll of the dice in craps). Furthermore, even where a winning game outcome is a result, the player is readily able to let the winnings ride or at least leave the original wagers in place with little to no action or gesturing on the part of the player.

While this type of wagering and playing dynamic can appeal to the psychology of many players, craps and other similar fast paced table games can often be intimidating to new players. There are many bet types and rules to learn, the action is often fast and loud, and the game is typically played with live dealers/stickmen and other live players. Furthermore, craps and other fast paced live table games do not appeal to a significant segment of casual players who enjoy “softer” games where more focus is placed on the entertainment aspects of the game as opposed to the wagering and social aspects of the game. For example, many players are happy to conduct lengthy gaming sessions at penny slot machines, video poker machines, keno, and other types of electronic gaming machines.

While many systems and methods used to provide both table based and machine based wagering games and gaming experiences have generally worked well in the past, there is always a desire to provide further systems and methods to allow for a wider variety of enjoyable and different games and gaming systems for all manner of players. In particular, what is desired is the ability to provide various table game elements, such as a compounding bet dynamic, in the context of games provided on electronic gaming machines.

### SUMMARY

It is an advantage of the present invention to provide electronic gaming machines and systems that feature games having a compounding bet dynamic and/or other table game type elements thereon. This can be accomplished at least in part through the use of gaming machines and systems that feature a casual or soft theme that includes a primary game as well as a secondary game mechanic that can include persistent wagering or action over a plurality of discrete games.

A wide variety of different themes can be used for such primary and secondary games, and such themes can be separate or related across the primary and secondary games. In one particular example, a farm theme can be used. Within the game, players can win primary game credits by lining up posted symbol combinations as in a traditional reel game, and can also win secondary game based crops (e.g., strawberries, corn, and the like) that are displayed on the game screen within a virtual farm. Players may choose to sell these crops at any time (i.e., “cash them out”) or players may choose to leave them in play over multiple games. On subsequent primary spins or plays, crops that are not cashed out may multiply, may become reduced or eliminated, or may pay out dividends all based on various game outcome indicia, such as sub-symbols appearing on the reels in a reel based primary game.

In various embodiments of the present invention, a processor-based gaming machine adapted for accepting monetary wagers, playing primary games based on the wagers and granting payouts based on the results of the wager-based primary games can be provided. The gaming machine can include an exterior housing arranged to contain a plurality of internal gaming machine components therein, a master gaming controller in communication with the internal gaming machine components and adapted to execute or control one or more aspects of the wager-based primary games, a display device in communication with the master gaming controller and adapted to present one or more aspects of the wager-based primary games thereupon, and a secondary game component in communication with said master gaming controller and adapted to execute or control one or more aspects of a secondary game that is associated with said wager-based primary games. The secondary game can include the use of persisting credits having a monetary value that remain across the play of multiple discrete primary games. Such persisting credits preferably have a value that can rise, fall, or remain constant based on the play of a discrete primary game, and the persisting credits preferably can be cashed out by a player at any time.

In various detailed embodiments, all or at least a portion of said secondary game component can be included within the master gaming controller itself. Alternatively, or in combination, at least a portion of the secondary game component can be included at a server in communication with and located remotely from the processor-based gaming machine. In various embodiments, the primary games can involve a reel based game that uses reel symbols to indicate the outcome of the primary game. In such embodiments, the secondary game can use sub-symbols on the primary game reels to indicate the progression of the secondary game. Alternatively, or in addition, the secondary game can have outcome indicators that are entirely separate from the outcome indicators for the primary games. In addition, the secondary game can include periodic offers to the player to cash out at least a portion of the persisting credits, such as at a value higher than the regular value of the portion.

In various embodiments, the secondary game can comprise a themed game, which may involve a farm, a city, a zoo, a military, an auto race, a sporting event, an adventure, a treasure hunt or the like. In such embodiments, each player can be permitted to develop and maintain a virtual entity based upon the theme, such as a farm having a variety of growing crops or animals. Alternatively, or in addition, the secondary game can include the provision of virtual vanity items or statuses for players. Such virtual vanity items or statuses can be obtained by players through the use of the persisting credits, for example. Further, the virtual vanity items or statuses can persist for players across separate gaming sessions and/or gaming machines. In addition, information regarding the secondary game can be provided to one or more outside devices such that the provided secondary game information is made available to players on a separate social gaming venue. Such an embodiment can include the use of a communication interface on the gaming machine or system that is adapted to communicate with outside devices.

In general virtual vanity items or status can be awarded at any stage during a play of a primary game or a secondary game. In some embodiments, virtual vanity items or status can be merely ornamental. In other embodiments, a previous award of the virtual vanity items can result in an increase an expected value of a future bonus or increase the chances of winning a future bonus.

In further embodiments, various methods of providing persistent secondary games associated with primary games that involve monetary wagers are provided. Such methods can include the process steps of accepting a first monetary wager from a player at a gaming machine, providing a first primary game play event at the gaming machine based upon the first monetary wager, determining a first primary game outcome based upon the first primary game play event, granting a first monetary award to the player based upon the first primary game outcome, determining an initial secondary game outcome in association with the first primary game play event, wherein said initial secondary game outcome does not require any additional monetary wager from the player, granting a persistent credit having a monetary value to the player based upon the initial secondary game outcome, and providing an opportunity to the player to redeem said persistent credit prior to the play of a second primary game play event. Additional process steps can then include accepting a second monetary wager from the player, providing the second primary game play event based upon the second monetary wager, said second primary game play event being separate and discrete from said first primary game play event, wherein said second primary game play event is provided after the player has elected not to redeem said persistent credit, determining a second primary game outcome based upon the second primary game play event, granting a second monetary payout to the player based upon the second primary game outcome, determining a subsequent secondary game outcome in association with the second primary game play event, wherein said subsequent secondary game outcome does not require any additional monetary wager from the player, and adjusting the value of said persistent credit based upon the subsequent secondary game outcome. In some instances, the step of adjusting can result in the value of said persistent credit being decreased. An additional process step can involve maintaining a database of stored player profiles that include individual player data regarding the secondary game. Further steps associated with administering the game on a remote server are also possible.

In still further embodiments, gaming systems adapted to provide persistent secondary games associated with primary games that involve monetary wagers are provided. Such gaming systems can include a plurality of gaming machines adapted to provide secondary games, such as that which is disclosed above, as well as a database storing a plurality of player profiles that include individual player data regarding said secondary games, and a remote secondary game server that can be in communication with the plurality of gaming machines and the database. The remote secondary game server can include a processor, a memory and a network interface, and can be configured at least to receive information regarding gaming activity by a player from said one of the plurality of gaming machines, determine whether the player is associated with an existing player profile stored on the database, provide data to the gaming machine regarding a customized status of a secondary game for the player when it is determined that the received information is associated with an existing player profile stored on the database, and update the existing player profile based upon gaming activity at the gaming machine when it is determined that the received information is associated with an existing player profile stored on the database. Further details regarding the provided gaming systems can follow from the various details provided above with respect to individual gaming machines.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive systems and methods for providing gaming machines having persistent secondary games. These drawings in no way limit any changes in form and detail that may be made to the invention by one skilled in the art without departing from the spirit and scope of the invention.

FIG. 1 illustrates in front perspective view an exemplary gaming machine.

FIG. 2 illustrates in front perspective view an exemplary gaming machine with its main door opened.

FIG. 3 illustrates in block diagram format an exemplary control configuration for use in a processor based gaming machine.

FIG. 4 illustrates in block diagram format an exemplary network infrastructure for providing a gaming system having one or more gaming machines.

FIG. 5 illustrates in block diagram format an exemplary specialized gaming system adapted for providing a persistent secondary game according to one embodiment of the present invention.

FIG. 6A provides a screenshot of an exemplary persistent secondary game environment having a “money farm” theme according to one embodiment of the present invention.

FIG. 6B provides a screenshot of an exemplary primary game associated with the persistent secondary game of FIG. 6A according to one embodiment of the present invention.

FIG. 7A provides another screenshot of the exemplary persistent secondary game “money farm” environment of FIG. 6A having no items or value displayed according to one embodiment of the present invention.

FIG. 7B provides an exemplary series of primary game reel symbols that can result in a positive secondary game result according to one embodiment of the present invention.

FIG. 7C provides another screenshot of the exemplary persistent secondary game “money farm” environment of FIG. 7A after the positive result of FIG. 7B has been awarded according to one embodiment of the present invention.

FIG. 8A provides a screenshot of an exemplary accounting or paytable for the persistent secondary game “money farm” theme according to one embodiment of the present invention.

FIG. 8B provides an exemplary series of primary game reel symbols and secondary game sub-symbols for the “money farm” themed secondary game according to one embodiment of the present invention.

FIG. 9A provides an exemplary primary game reel symbol and secondary game “gifting” sub-symbol for the persistent secondary game “money farm” theme according to one embodiment of the present invention.

FIG. 9B provides a screenshot of an exemplary choice of gifts for the persistent secondary game having a “money farm” theme according to one embodiment of the present invention.

FIG. 9C provides another screenshot of the exemplary persistent secondary game “money farm” environment of FIG. 7A after a selected gift from the choices in FIG. 9B has been placed according to one embodiment of the present invention.

FIG. 10 illustrates in block diagram format an exemplary persistent secondary game player profile according to one embodiment of the present invention.

FIG. 11 provides a flowchart of an exemplary method of providing a persistent secondary game associated with primary games that involve monetary wagers according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The invention relates in various embodiments to persistent secondary games that are provided in association with primary games, such as on an electronic gaming machine (“EGM”), system or network. Electronic gaming machines or devices for use with the present invention can be, for example, any of the processor based gaming machines provided by IGT of Reno, Nev., or any other gaming machine or system provider. Although the subject gaming machines and systems can be adapted to provide a wager based game of chance by displaying video data that simulates a mechanical reel, it will be readily appreciated that the various embodiments of the present invention disclosed herein can also be used with gaming machines that provide or simulate wheels, cards, bingo items, keno items, racing icons, sporting icons and a wide variety of other gaming items. Further, the present invention can also be used in some instances in conjunction with other machines and items that are not limited to processor based or wager based games. For example, purely mechanical gaming machines or gaming machines adapted to provide games that are not wager based can also be used in some adaptations.

### Gaming Machines and Systems

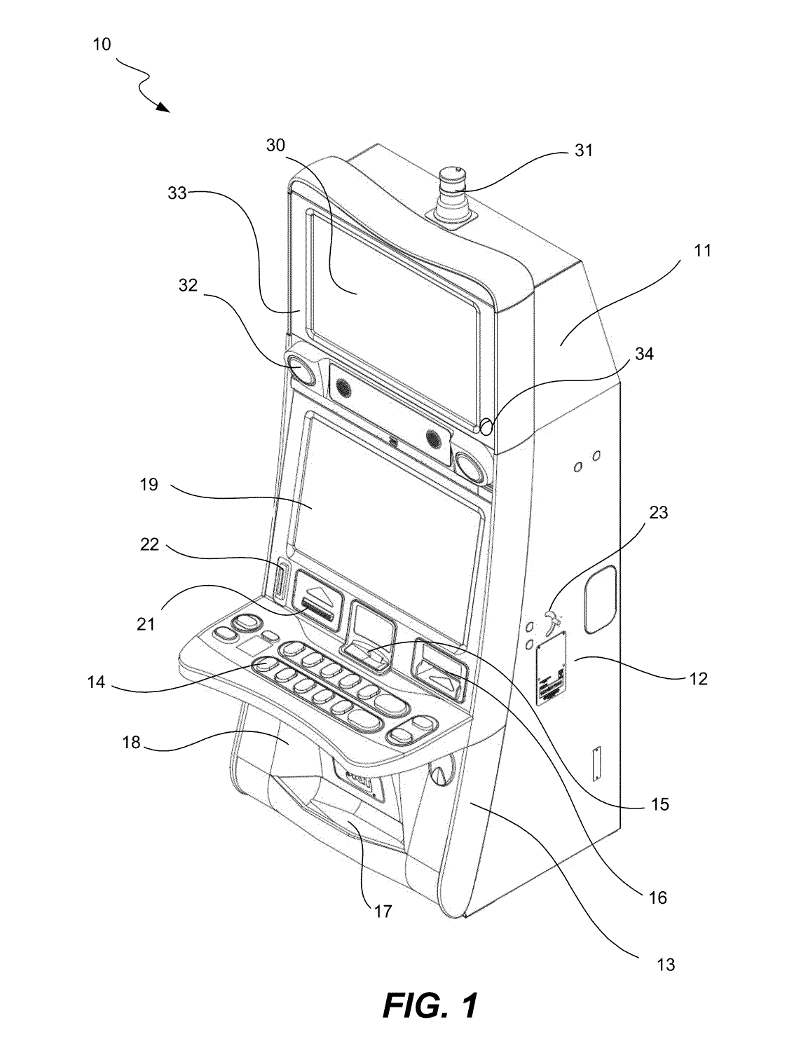

Referring first to FIG. 1, one example of a processor based gaming machine in is shown in front perspective view. Gaming machine 10 is one example of what can be considered a “thick-client” device. Typically, a thick-client device is configurable to communicate with one or more remote servers, but provides game play independent of the remote servers. Such independent game play can include game outcome determination, for example. In addition, a thick-client device can be considered as such because it includes cash handling capabilities, such as peripheral devices for receiving cash, and a secure enclosure within the device for storing the received cash. In contrast, a thin-client device, such as a mobile gaming device, may be more dependent on a remote server to provide a component of the game play on the device, such as game outcome determination, and/or may not include peripheral devices for receiving and securely storing cash.

Many different configurations are possible between thick and thin clients. For instance, a thick-client device, such as gaming machine 10, deployed in a central determination configuration, may receive game outcomes from a remote server but still provide cash handling capabilities. Further, the peripheral devices can vary from gaming device to gaming device. For instance, gaming machine 10 can be configured with electro-mechanical reels to display a game outcome instead of a video display. Thus, the various features and peripherals of gaming machine 10 are described for the purposes of illustration only, and are not meant to be limiting. One of skill in the art will readily appreciate numerous other peripherals and differences not set forth herein.

As shown, gaming machine 10 can include a top box 11 and a main cabinet 12, which defines an interior region of the gaming machine. The cabinet includes one or more rigid materials to separate the machine interior from the external environment, is adapted to house a plurality of gaming machine components within or about the machine interior, and generally forms the outer appearance of the gaming machine. Main cabinet 12 includes a main door 13 on the front of the machine, which opens to provide access to the interior of the machine. The interior may include any number of internal compartments, such as for cooling and security purposes, among others. Attached to the main door or cabinet are typically one or more player-input switches or buttons 14; one or more money or credit acceptors, such as a coin acceptor 15, and a bill or ticket scanner and acceptor 16; a coin tray 17; and a belly glass 18. Viewable through main door 13 is a primary display monitor 19.

Top box 11, which typically rests atop of the main cabinet 12, may also contain one or more secondary or additional displays 30, a candle 31, one or more speakers 32, a top glass 33 and a camera 34, among other items. Various further gaming machine items can be located on the top box and/or main cabinet. For example, main cabinet 12 may also include a ticket printer 21, a card reader 22, and a locking mechanism 23 for main door 13, among other items. One or more of these components can be used to form a player tracking device, as will be readily appreciated. For example, card reader 22 can be part of a player tracking device that is integrated within the machine. One or more additional player tracking displays (not shown) may also be used in conjunction with these and/or other components. Further components and combinations are also possible, as is the ability of the top box to contain one or more items traditionally reserved for main cabinet locations, and vice versa. For example, the ticket printer or various integrated player tracking components may be located on the top box for some gaming machines.

It will be readily understood that gaming machine 10 can be adapted for presenting and playing any of a number of games and gaming events, particularly games of chance involving a player wager and potential monetary payout, such as, for example, a digital slot machine game and/or any other video reel game, among others. While gaming machine 10 is usually adapted for live game play with a physically present player, it is also contemplated that such a gaming machine may also be adapted for remote game play with a player at a remote gaming terminal. Such an adaptation preferably involves communication from the gaming machine to at least one outside location, such as a remote gaming terminal itself, as well as the incorporation of a gaming network that is capable of supporting a system of remote gaming with multiple gaming machines and/or multiple remote gaming terminals.

Gaming machine 10 may also be a “dummy” machine, kiosk or other “thin” gaming terminal, in that all processing may be done at a remote server, with only the external housing, displays, and pertinent inputs and outputs being available to a player. Further, it is also worth noting that the term “gaming machine” may also refer to a wide variety of gaming machines in addition to traditional free standing gaming machines. Such other gaming machines can include kiosks, set-top boxes for use with televisions in hotel rooms and elsewhere, and many server based systems that permit players to log in and play remotely, such as at a personal computer, personal digital assistant, cellular telephone or tablet computer, among other possible devices. All such gaming machines can be considered “gaming machines” for embodiments described herein.

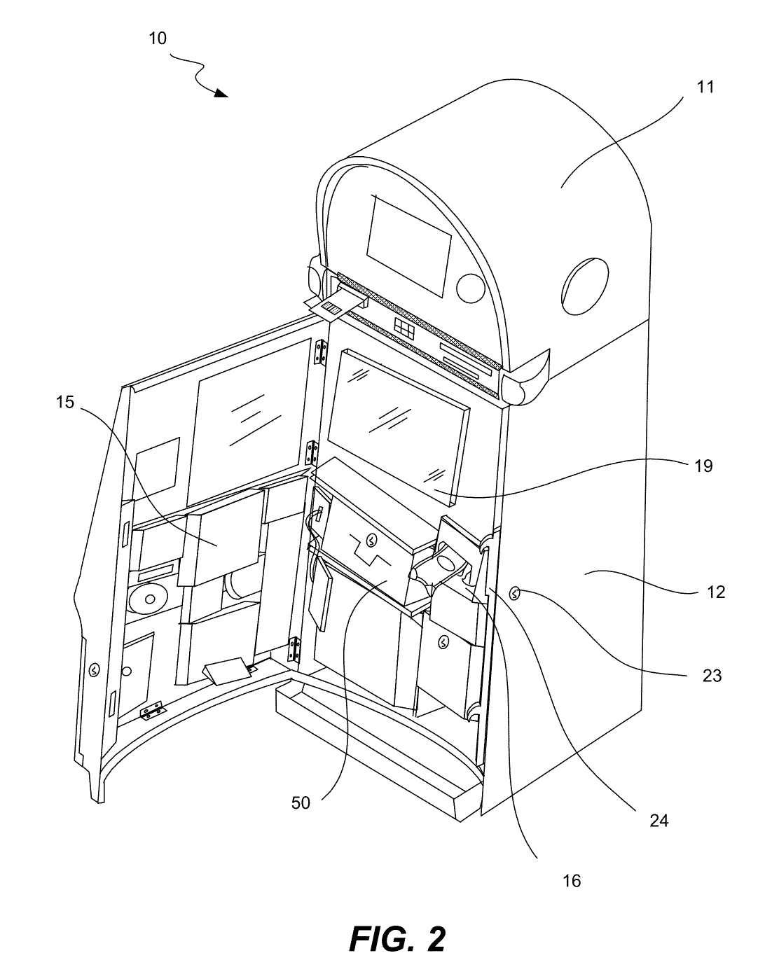

Continuing with FIG. 2, an exemplary gaming machine is illustrated in front perspective view with its main door opened. In additional to the various exterior items described above, such as top box 11, main cabinet 12 and primary display 19, gaming machine 10 also comprises a variety of internal components. As will be readily understood by those skilled in the art, gaming machine 10 can include a variety of locks and mechanisms, such as main door lock 23 and an associated latch 24. Internal portions of coin acceptor 15 and bill or ticket scanner 16 can also be seen, along with the physical meters associated with these peripheral devices. Processing system 50 can include gaming machine computer architecture, which can be secured away within a restricted region inside the gaming machine, as will be readily appreciated.

When a person wishes to play a gaming machine 10, he or she provides coins, cash, tickets or a credit device to a scanner included in the gaming machine. The scanner may comprise a bill scanner or a similar device configured to read printed information on a credit device such as a paper ticket or magnetic scanner that reads information from a plastic card. The credit device may be stored in the interior of the gaming machine. During interaction with the gaming machine, the person views game information using a display. Usually, during the course of a game, a player is required to make a number of decisions that affect the outcome of the game. The player makes these choices using a set of player-input switches. A game ends with the gaming machine providing an outcome to the person, typically using one or more of the displays.

After the player has completed interaction with the gaming machine, the player may receive a portable credit device from the machine that includes any credit resulting from interaction with the gaming machine. By way of example, the portable credit device may be a ticket having a dollar or other monetary value produced by a printer within the gaming machine. A record of the credit value of the device may be stored in a memory device provided on a gaming machine network (e.g., a memory device associated with validation terminal and/or processing system in the network). Any credit on some devices may be used for further games on other networked gaming machines 10. Alternatively, the player may redeem the device at a designated cashier, change booth or pay machine.

Gaming machine 10 can be used to play any primary game, bonus game, progressive or other type of game. Gaming machine 10 can also enable a player to view information and graphics generated on one display screen while playing a game that is generated on another display screen. Such information and graphics can include game paytables, game-related information, entertaining graphics, background, history or game theme-related information, or information not related to the game, such as advertisements. The gaming machine can display this information and graphics adjacent to a game, underneath or behind a game or on top of a game. For example, a gaming machine could display paylines on a proximate display screen and also display a reel game on a distal display screen, and the paylines could fade in and fade out periodically.

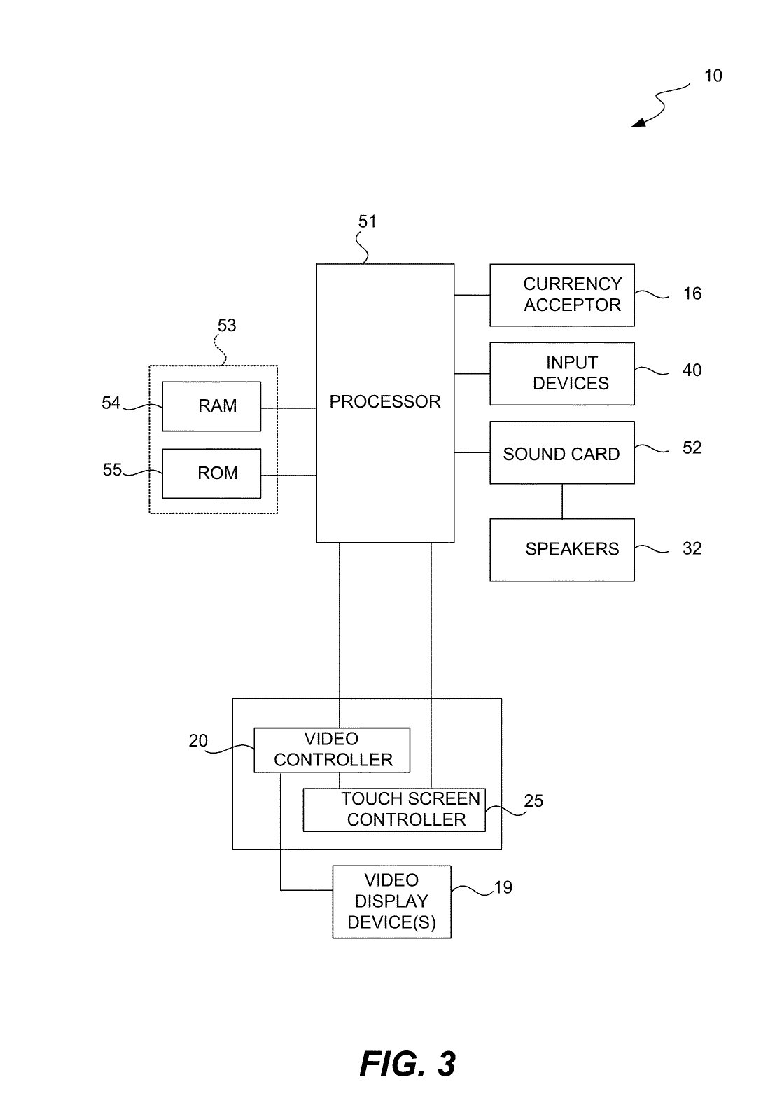

An electronic gaming machine can also include one or more processors and memory or other storage components that cooperate to output games and gaming interaction functions from stored memory. To this extent, FIG. 3 illustrates a block diagram of an exemplary control configuration for use in a processor based gaming machine 10. Primary processor or processing system 51 can be a microprocessor or microcontroller-based platform that includes one or more commercially available microprocessors provided by a variety of vendors known to those of skill in the art. Processor or processing system 51 can be a master gaming controller (“MGC”) that is responsible for game determination and monetary accounting functions, among various other gaming machine functions. MGC 51 is preferably in communication with and capable of causing a display device 19 to output data such as symbols, cards, images of people, characters, places, and objects which function in the gaming device. Display device 20 can be associated with a video controller 19 dedicated to the display and that communicates with processor 51. A touch screen controller 25 adapted to accept input from a touch screen associated with display 19 can also be in communication with processor 51 and video controller 20.

Gaming machine 10 may also include one or more application-specific integrated circuits (“ASICs”) or other hardwired devices. One or more dedicated memory or storage components 53 may include one or more memory modules, flash memory or another type of conventional memory that stores executable programs that are used by the processing system to control various gaming machine components. Memory 53 can include any suitable software and/or hardware structure for storing data, including a tape, CD-ROM, floppy disk, hard disk or any other optical or magnetic storage media. Memory 53 may also include a) random access memory (“RAM”) 54 for storing event data or other data generated or used during a particular game and b) read only memory (“ROM”) 55 for storing program code that controls functions on the gaming machine such as playing a game. Although the processor 51 and memory devices 53 can reside the gaming machine itself 10, it is possible to provide some or all of their functions at a central location such as a network server for communication to a playing station such as over a local area network (“LAN”), wide area network (“WAN”), Internet connection, microwave link, and the like.

In various embodiments, a player can use one or more input devices 40, such as a pull arm, play button, bet button or cash out button to input signals into the gaming machine 10. One or more of these functions could also be employed on a touch screen. In such embodiments, the gaming machine 10 can include a touch screen controller 25 that communicates with a video controller 20 or processor 51. A player can input signals into the gaming machine by touching the appropriate locations on the touch screen. Processor 51 also communicates with and/or controls other elements of gaming machine 10. For example, this includes providing audio data to sound card 52, which then provides audio signals to speakers 32 for audio output. Various commercially available sound cards and speakers are suitable for use with gaming machine 10. Processor 51 can also be connected to a currency acceptor 16 such as the coin slot or bill acceptor. Processor 51 can operate instructions that require a player to deposit a certain amount of money in order to start the game.

Although the processing system shown in FIG. 3 is one specific processing system, it is by no means the only processing system architecture on which embodiments described herein can be implemented. Regardless of the processing system configuration, it may employ one or more memories or memory modules configured to store program instructions for gaming machine network operations and operations associated with layered display systems described herein. Such memory or memories may also be configured to store player interactions, player interaction information, and other instructions related to steps described herein, instructions for one or more games played on the gaming machine, and so forth.

Because such information and program instructions may be employed to implement the systems/methods described herein, the present invention relates to machine-readable media that include program instructions, state information, and the like for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher-level code that may be executed by the computer using an interpreter.

The processing system may offer any type of primary game, bonus game or other game. In one embodiment, a gaming machine permits a player to play two or more games on two or more display screens at the same time or at different times. For example, a player can play two related games on two display screens simultaneously. In another example, once a player deposits currency to initiate the gaming device, the gaming machine allows a person to choose from one or more games to play on different display screens. In yet another example, the gaming device can include a multi-level bonus scheme that allows a player to advance to different bonus rounds that are displayed and played on different display screens.

In various embodiments, gaming machine 10 can utilize a “state” machine architecture. In such a “state” machine architecture, critical information in each state is identified and queued for storage to a persistent memory. The architecture does not advance to the next state from a current state until all the critical information that is queued for storage for the current state is stored to the persistent memory. Thus, if an error condition occurs between two states, such as a power failure, the gaming device implementing the state machine can likely be restored to its last state prior to the occurrence of the error condition using the critical information associated with its last state stored in the persistent memory. This feature is often called a “roll back” of the gaming machine or device. Examples of critical information can include, but are not limited to, an outcome determined for a wager-based game, a wager amount made on the wager-based game, an award amount associated with the outcome, credits available on the gaming device, and a deposit of credits to the gaming device.

In various embodiments, gaming machine 10 can also include one or more secondary controllers (not shown). Such secondary controllers can be associated with various peripheral devices coupled to the gaming machine, such as value input devices and value output devices. As another example, one or more of such secondary controllers can be associated with peripheral devices, such as input devices, video displays, electro-mechanical displays, and a player tracking unit, among other possibilities. In some embodiments, a secondary controller can receive instructions and/or data from and provide responses to the MGC or primary processor 51. The secondary controller can be configured to interpret the instructions and/or data from the MGC, and also to control a particular device according to the received instructions and/or data. Additional such controllers may also be possible.

In some embodiments, a secondary controller can be used to control a number of peripheral devices independently of primary processor 51. For instance, a player tracking unit can include one or more of a video display, a touch screen, card reader, network interface, input buttons and the like. A player tracking controller can serve as a secondary controller to control these devices, such as to provide player tracking services and bonusing on gaming machine 10. Alternatively, the primary processor 51 can control these devices to perform player tracking functions. An advantage of performing player tracking functions via a secondary controller, such as a player tracking controller, is software on the player tracking unit can be developed and modified via a less lengthy and regulatory intensive process than is required for software executed by the primary processor 51. In general, certain functions of the gaming machine that are not subject to as much regulatory scrutiny as the primary wager-based game play functions can be decoupled from the primary processor 51 and implemented on a secondary controller instead. An advantage of this approach, such as for a player tracking controller, is that software approval process for the software executed by the secondary controller can be relatively less intensive.

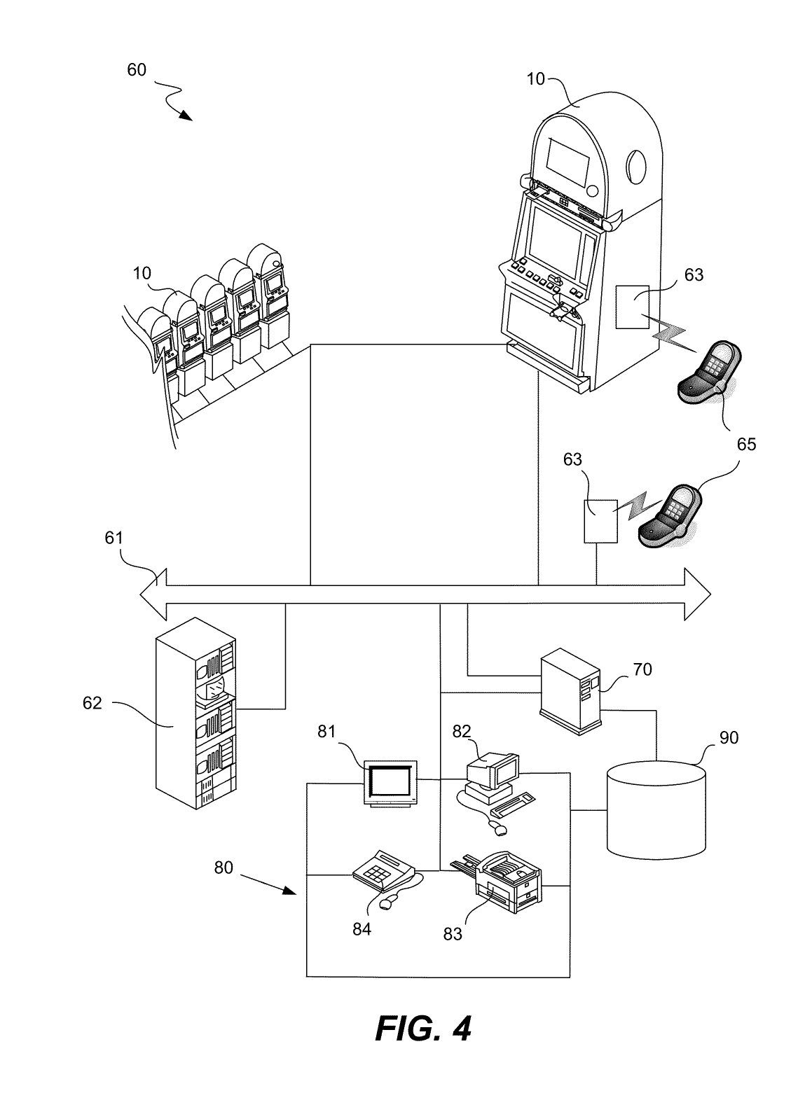

Continuing with FIG. 4, an exemplary network infrastructure for providing a gaming system having one or more gaming machines is illustrated in block diagram format. Exemplary gaming system 60 has one or more gaming machines, various communication items, and a number of host-side components and devices adapted for use within a gaming environment. As shown, one or more gaming machines 10 adapted for use in gaming system 60 can be in a plurality of locations, such as in banks on a casino floor or standing alone at a smaller non-gaming establishment, as desired. A common bus 61 can connect one or more gaming machines or devices to a number of networked devices on the gaming system 60, such as, for example, a general-purpose server 62, one or more special-purpose servers 70, a sub-network of peripheral devices 80, and/or a database 90. Additional system devices (not shown) can include table gaming devices associated with table games where a live operator or a virtual operator is employed, and also mobile gaming devices, which may be owned by the gaming establishment and/or players themselves. The network can include wired, wireless or a combination of wired and wireless communication connections and associated communication routers.

In some embodiments, a mobile device interface 63 can be provided for communicating with a mobile device 65, such as a pager, PDA, cell phone, tablet computer or other wireless communications device carried by players or casino personnel. Such a mobile device interface 63 can be on a gaming machine 10, and/or may be located elsewhere about the gaming floor. A wireless communication protocol, such as Bluetooth™ and a Wi-Fi compatible standard, can be used for communicating with various mobile devices 63 via mobile device interfaces 65. Alternatively, or in addition, the mobile device interface can implement a short range communication protocol, such as a near-field communication (“NFC”) protocol used for mobile wallet applications. NFC is typically used for communication distances of 4 cm or less. In addition, a wired communication interface, such as a docking station, can be integrated into the gaming machine. Such a wired communication interface can be configured to provide communications between the gaming machine 10 and the mobile device 65, and/or may provide power to the mobile device, such as to recharge a battery in the mobile device.

A general-purpose server 62 may be one that is already present within a casino or other establishment for one or more other purposes beyond any monitoring or administering involving gaming machines. Functions for such a general-purpose server can include other general and game specific accounting functions, payroll functions, general Internet and e-mail capabilities, switchboard communications, and reservations and other hotel and restaurant operations, as well as other assorted general establishment record keeping and operations. In some cases, specific gaming related functions such as cashless gaming, downloadable gaming, player tracking, remote game administration, video or other data transmission, or other types of functions may also be associated with or performed by such a general-purpose server. For example, such a server may contain various programs related to cashless gaming administration, player tracking operations, specific player account administration, remote game play administration, remote game player verification, remote gaming administration, downloadable gaming administration, and/or visual image or video data storage, transfer and distribution, and may also be linked to one or more gaming machines, in some cases forming a network that includes all or many of the gaming devices and/or machines within the establishment. Communications can then be exchanged from each adapted gaming machine to one or more related programs or modules on the general-purpose server.

In one embodiment, gaming system 60 contains one or more special-purpose servers 70 that can be used for various functions relating to the provision of persistent secondary games, such as those set forth in greater detail below. Such a special-purpose server or servers 70 could have one or more processors, storage units, network interfaces and specifically adapted software thereon, and may include, for example, a cashless gaming server, a player verification server, a player tracking server, a general game server, a downloadable games server, a specialized accounting server, a visual image or video distribution server, and/or a persistent secondary game server, among others. Of course, these functions may all be combined onto a single specialized server. Such additional special-purpose servers are desirable for a variety of reasons, such as, for example, to lessen the burden on an existing general-purpose server or to isolate or wall off some or all gaming machine administration and operations data and functions from the general-purpose server and thereby increase security and limit the possible modes of access to such operations and information.

Alternatively, exemplary gaming system 60 can be isolated from any other network at the establishment, such that a general-purpose server 62 is essentially impractical and unnecessary. Under either embodiment of an isolated or shared network, one or more of the special-purpose servers are preferably connected to sub-network 80, which might be, for example, a cashier station or terminal. Peripheral devices in this sub-network may include, for example, one or more video displays 81, one or more user terminals 82, one or more printers 83, and one or more other input devices 84, such as a ticket validator or other security identifier, among others. Similarly, under either embodiment of an isolated or shared network, at least the specialized server 70 or another similar component within a general-purpose server 62 also preferably includes a connection to a database or other suitable storage medium 90. Database 90 is preferably adapted to store many or all files containing pertinent data or information for a particular purpose, such as, for example, data regarding persistent secondary games, which may include tracked player statuses and information, among other potential items. Files, data and other information on database 90 can be stored for backup purposes, and are preferably accessible at one or more system locations, such as at a general-purpose server 62, a special purpose server 70 and/or a cashier station or other sub-network location 80, as desired.

While gaming system 60 can be a system that is specially designed and created new for use in a casino or gaming establishment, it is also possible that many items in this system can be taken or adopted from an existing gaming system. For example, gaming system 60 could represent an existing cashless gaming system or player tracking system, to which one or more of the inventive components or controller arrangements are added, such as controllers, storage media, and/or other components that may be associated with a dynamic display system adapted for use across multiple gaming machines and devices. In addition to new hardware, new functionality via new software, modules, updates or otherwise can be provided to an existing database 90, specialized server 70 and/or general-purpose server 62, as desired. Other modifications to an existing system may also be necessary, as might be readily appreciated.

### Persistent Secondary Games

As noted above, the present invention is particularly directed toward electronic gaming machines and systems that feature games having a persistent secondary game element. Such an element can involve a compounding bet dynamic, such as that which is featured in craps or other fast paced table games. In particular, the secondary game and its compounding bet dynamic can involve the provision of secondary game indicia and outcomes that are associated with primary game wagers, plays and outcomes. Unlike many traditional primary games played on electronic gaming machines, however, the secondary game can feature a dynamic where it's wagering or risk taking is persistent across multiple discrete game plays. This can result in more excitement and anticipation and bigger wins during hot streaks, as well as significant down sides during a bad turn (e.g., “craps”).

The persistent secondary game can be theme based, so as to provide more entertainment value to the types of players that enjoy playing electronic gaming machines for the entertainment value of the gaming experience. Again, a wide variety of different themes can be used for such primary and secondary games, and such themes can be separate or related across the primary and secondary games. Such themes can involve, for example, a farm, a circus, a city, a zoo, a military, an auto race, a sporting event, an adventure and a treasure hunt, among many other possible themes. Although the various examples, discussions and screen shots provided herein are disclosed with respect to a specific “Money Farm” example, it will be readily appreciated that such examples are only illustrative in nature, and that analogous implementations for other themes may readily be implemented.

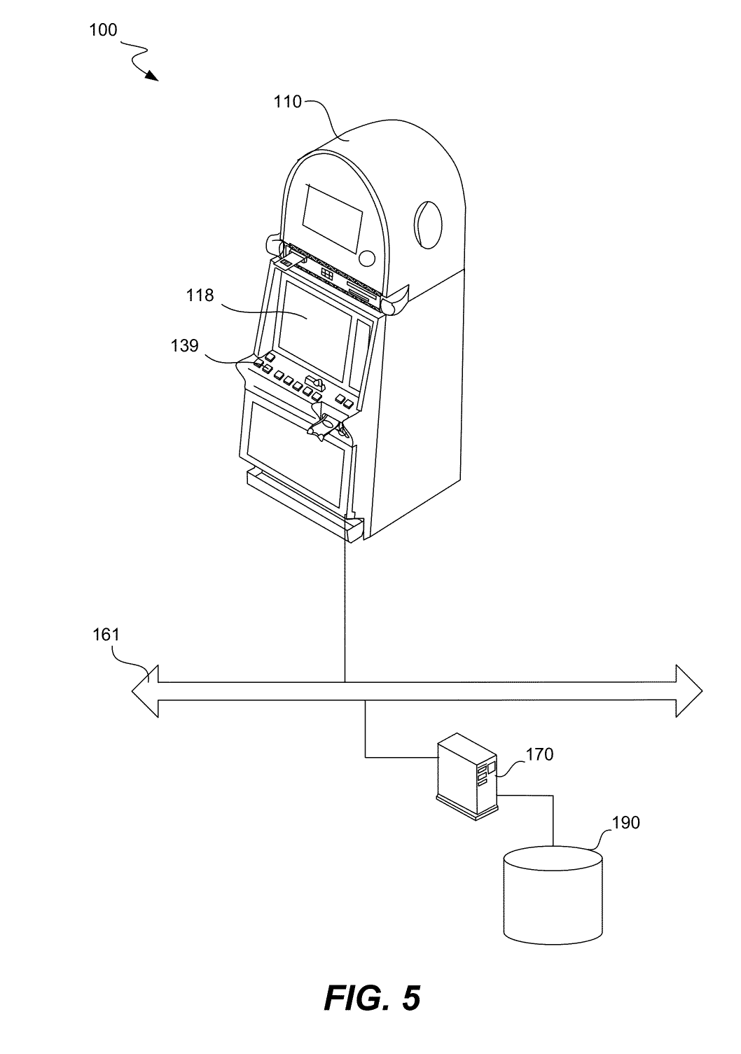

Turning now to FIG. 5, an exemplary specialized gaming system adapted for providing a persistent secondary game according to one embodiment of the present invention is shown in block diagram format. Exemplary specialized gaming system 100 can be similar to gaming system 60 above, with a few key differences. Also, it will be understood that various components from gaming system 60 above may still be present in gaming system 100, although such components are not shown again in FIG. 5 simply for purposes of focus and discussion. Gaming system 100 can include a specialized gaming machine 110 that is adapted for providing a persistent secondary game. Such a specialized gaming machine 110 can include an input display touch screen 118 that is adapted to provide a primary display, a touch screen input function to players, as well as one or more input buttons 139. Such a touch screen 118 and/or buttons 139 can be used by players not only to make wagers and initiate gaming plays, but also to customize and maintain their own personal farms or other persistent secondary gaming environments.

In addition to specialized gaming machine 110, the specialized gaming system 100 can also include a common bus 161 or other suitable communication means to connect one or more gaming machines or devices to a number of networked devices on the system. Such networked devices can include one or more special-purpose servers 170 and one or more databases 190 that are both adapted to facilitate the administration or provision of persistent secondary games. Again, such special-purpose server(s) could have one or more processors, storage units, network interfaces and specifically adapted software thereon that facilitate the administration of persistent secondary games. In general, specialized EGMs 110, other devices on the casino floor (not shown), backroom server(s) 170 and/or database(s) 190 can have hardware and software that are adapted for use with one or more specific persistent secondary games. Such hardware and software components can be adapted to convert existing gaming systems to result in specialized system 100 to the extent that such conversions with existing systems may be suitable.

In any such embodiments of new or converted specialized gaming systems 100, individual player profiles for numerous different players can be maintained at database 190. Such player profiles can contain specific information or data regarding the progress or status of each individual player with respect to any persistent credit levels and overall progression of the player within one or more secondary games. Again, such progression can be with respect to a themed secondary game, and can involve the use of virtual gifts, vanity items, statuses, or other such indicators. These items can terminate at the end of a particular gaming session, or can persist across multiple gaming sessions for an extended period of time or indefinitely where the player can be identified, such as by a player tracking card.

While various examples of specialized gaming machine(s) 100 provided herein are made with respect to reel based machines, it will be understood that virtually any gaming machine can be similarly adapted to provide the disclosed persistent secondary games and various features thereof. With respect to the reel type games, hitting symbol combos on the specialized gaming machine(s) 100 can lead to two different payouts: 1) a first sum of monetary credits being added to the machine credit meter with respect to the primary game on the machine, and 2) a second sum of credits that is added to a side account or a “persistent secondary account.” Such persistent credits preferably have an actual monetary value.

In one particular example, a farm theme can be used. Within the game, players can win primary game credits by lining up posted symbol combinations as in a traditional reel game, and can also win secondary game based crops (e.g., strawberries, corn, and the like) that are displayed on the game screen within a virtual farm. Players may choose to sell these crops at any time (i.e., “cash them out”) or players may choose to leave them in play over multiple games. On subsequent primary spins or plays, crops that are not cashed out may multiply, may become reduced or eliminated, or may pay out dividends all based on various game outcome indicia, such as sub-symbols appearing on the reels in a reel based primary game.

In various particular farm theme examples, hitting 3 strawberry symbols on a primary game payline could lead to winning a direct payout to the primary game credit meter as well as winning a virtual strawberry for the secondary game. Such a virtual strawberry could then be displayed on the onscreen secondary game farm for the player. The player could then elect to sell this strawberry for a posted credit amount or keep the strawberry on his or her secondary game farm. Whenever the player initiates a play on the primary game and there are crops on his or her onscreen farm, various sub-symbol events could lead to: 1) payouts for crops currently on the farm (e.g., triggered by a farmers market reel symbol), 2) multiplying crops currently on the farm (e.g., triggered by sun or rain reel symbols), 3) no change to existing crops (e.g., no definitive secondary game symbol occurring), or 4) removing or reducing crops currently on the farm (e.g., triggered by insect or drought symbols). Before each primary game play, the player could be provided an opportunity to sell some or all of his or her persistent secondary game crops or to “let them ride” on the next play of the primary game. Again, similar examples can be extrapolated for secondary themes other than a farm game theme.

In order to simplify the interactivity, flow and entertainment value of the game, an offer mechanic can sometimes involve an onscreen “banker” character that may periodically make the player cash offers on his or her onscreen crops, which the player could either accept or decline. Such offers could be in excess of the current value of the crops or other secondary game credit value, and may be “one-time” special offer events. Such offers might also involve some form of promotional or cross-marketing activity, such as a special on a meal, show, hotel room or other item offered by the gaming establishment. In addition to the “banker” or other special offer character, the player can be provided an opportunity to cash out his or her persisting credits for the secondary game at any time in a regular manner.

An alternative version of the secondary game might award strawberry seeds instead of strawberries, and introduce the concept of growth or evolving value to the secondary game crops or credits. With each future spin on the primary game, the strawberries could grow and their redemption value could increase, such as until they hit a maximum size or bonus level payout. Sub-symbols on the reels for the primary games could also potentially trigger payouts for existing crops, cause crops to grow at an accelerated pace, or multiply, any of which results in an increase to the value of the persisting credits for the secondary game. In addition, such sub-symbols or events can result in crops withering or dying off, such as by a drought or insect infestation, with a subsequent reduction to the persisting credit balance.

While some embodiments can call for the use of sub-symbols on the reels to modify crops on the secondary game farm, an independent “weather reel” could also or alternatively be used. In this scenario, the weather reel might not impact primary game wagers, but rather would only affect the persistent secondary game and the physical appearance of the game as presented on the gaming machine. For example, if the weather reel landed on the sun symbol, then the gaming display background would appear sunny, while a rainy outcome could result in a cloudy and darker overall gaming display.

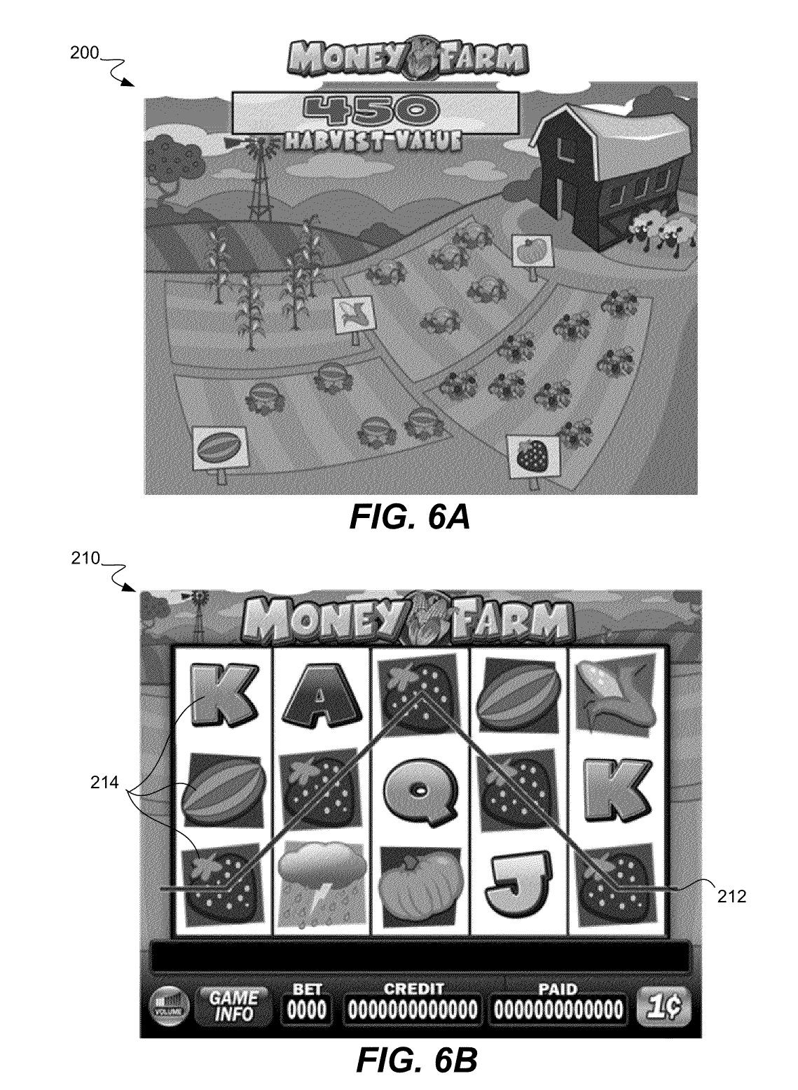

Moving now to FIGS. 6A through 9C, various screenshots and graphical examples of a persistent secondary game will now be discussed. FIG. 6A depicts a screenshot 200 of an exemplary persistent secondary game environment having a “money farm” theme. Such a secondary game can be displayed on a primary game display and/or on a secondary display at the gaming machine. In some embodiments, the farm display 200 can be shown temporarily on the primary game display at key moments or updates of the persistent secondary game status, while the farm display is always shown on a secondary display, such as a smaller or deemphasized display. Such a smaller display can persist, for example, in a display on the top glass or otherwise at the top box of the gaming machine. In some embodiments, the farm display 200 may even be made available to the player on a separate portable electronic device owned by the player, such as where the gaming machine is adapted to communicate with such devices and provide data or statuses to these devices for an enhanced gaming experience.

As shown, “Money Farm” display 200 can include an overall harvest value, which can represent the amount of persistent credits attributed to the player at that time. Such an amount can be given a “harvest value” label or tag, which can correlate to an actual cash value if the player elects to cash out his or her harvest value persistent credits. These credits can also be represented graphically on the farm as shown, such as by the sum value of all crops displayed on the farm. Such crops can be, for example, four corn crops, four watermelon crops, five pumpkin crops and eight strawberry crops, among numerous other possibilities. Other items may also have a harvest value, or may simply be decorative, vanity, gift or status like in nature. Such other items can include barns, vehicles, animals, windmills and the like.

FIG. 6B provides a screenshot 210 of an exemplary primary game associated with the persistent “Money Farm” secondary game of FIG. 6A. As shown, the primary game can be a penny slots type of game, although any other denomination and game type may alternatively be used. One or more paylines 212 can be made up of various reel symbols 214, as will be readily understood by those skilled in the art. In fact, the primary game shown in display 210 can be identical or substantially similar to virtually any primary game that is traditionally played on gaming machines. As shown, the payline 212 made up of five strawberry symbols can result in a monetary outcome or award for the primary game being played, and can also result in a separate outcome or award for the persistent secondary game. In various embodiments, certain results can result in an award for both the primary and secondary games, for either the primary or secondary game but not the other, or for neither game. In fact, some outcomes can result in a negative effect to the persistent credit balance with respect to the secondary game.

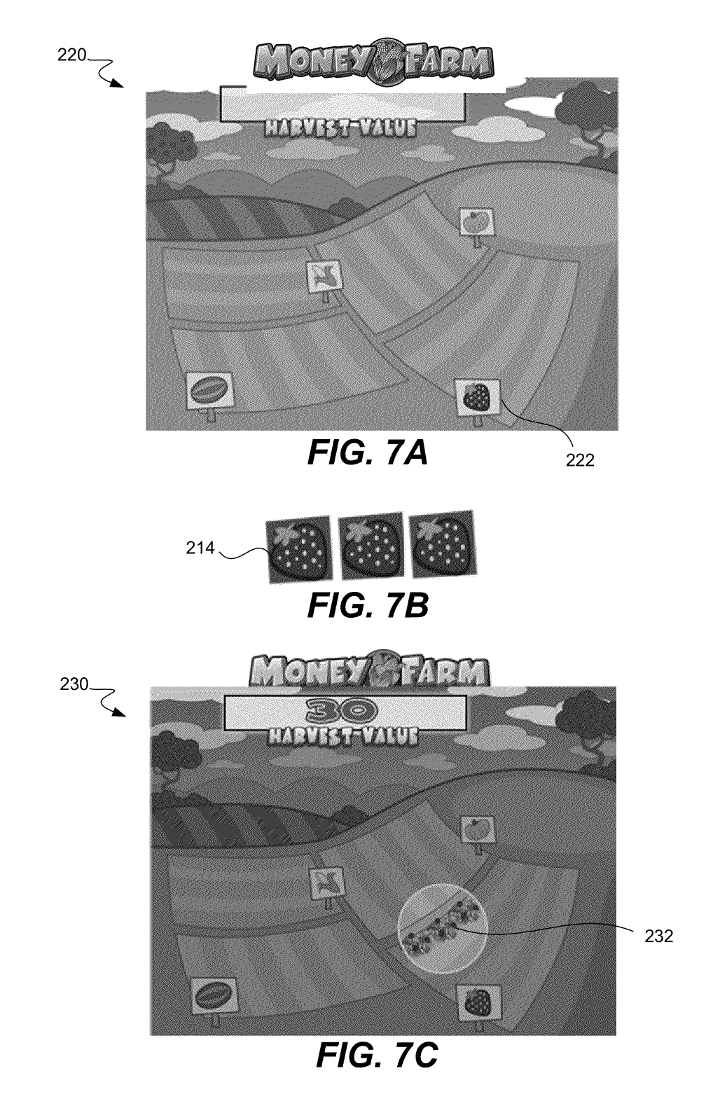

FIG. 7A provides another screenshot 220 of the exemplary persistent secondary game “Money Farm” environment of FIG. 6A as a blank slate or backdrop. As shown, the basic farm in display 220 has no crops, buildings, vehicles, animals, vanity items or special status, as well as no harvest value displayed. Such a base farm for screenshot 220 can be the blank slate or canvas that is the starting point for every new player to the persistent secondary game of “Money Farm.” Among the many features of this blank slate money farm, a strawberry plot 222 or section of farm can be provided.

Upon a first play of a primary game by a new player, three strawberries are hit, as shown by the series of primary reel symbols 214 in FIG. 7B. After, or concurrently with, any award is made to the player for such a result under the primary game, an award of three strawberries to the farm of that player may be made. As such, FIG. 7C provides another screenshot 230 of the exemplary persistent secondary game “Money Farm” environment of FIG. 7A after the positive result of FIG. 7B has been awarded to the player. As shown, three strawberries 232 are provided to the strawberry plot section of the farm for that player, and a harvest value of 30 is displayed as representative of the value of those three strawberries (as well as all other crops in that secondary game account—which is zero as shown).

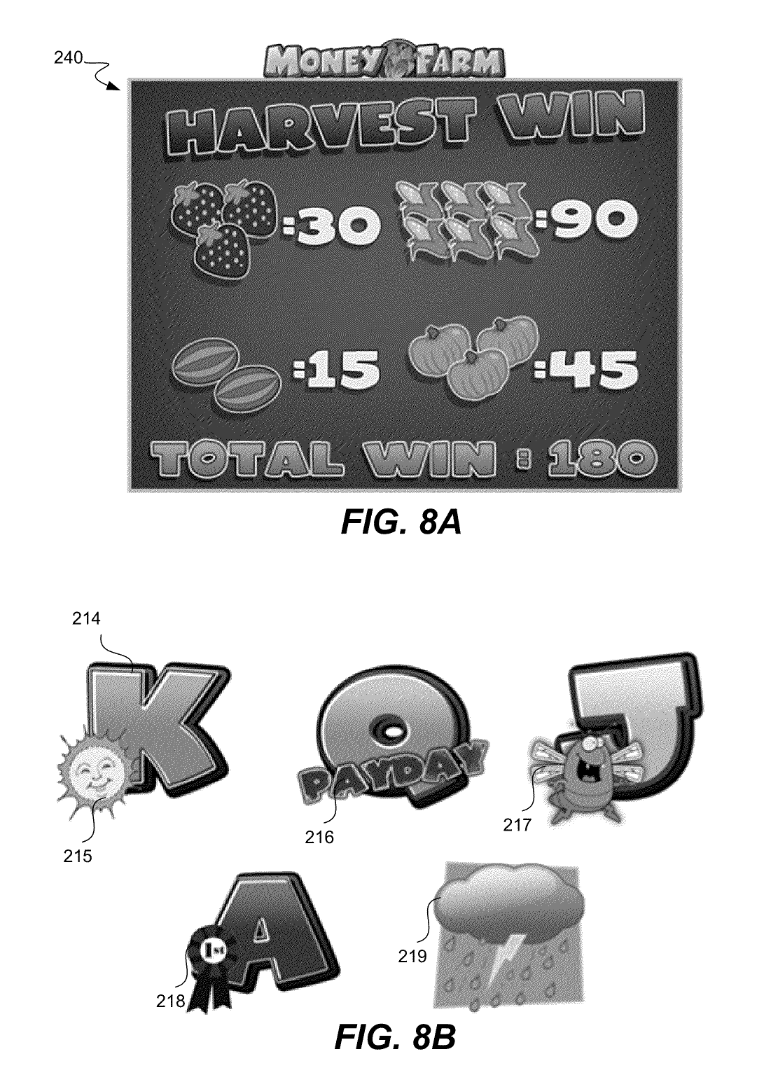

Moving next to FIG. 8A, a screenshot 240 of an exemplary accounting or paytable for the persistent secondary game “Money Farm” theme is shown. Such an accounting can be reflected on game signage on the machine, on one or more secondary or tertiary game displays, or on the primary display of the gaming machine at certain times, such as when requested by the player or during an actual accounting or cash out procedure, as will be readily appreciated. In this example shown, the various crops each have individual values, which are summed for each type of crop, and then summed together in total for a total harvest value of 180. Such a harvest value of 180 as shown can represent a secondary game win for a particular play of the primary game, which win may then be added to the overall harvest value (i.e., persistent credits) for the player and displayed on the farm display as a value and graphically as the various crops that make up that value.

In various embodiments, the virtual crops owned by the player have a real cash value that can be can be cashed out or converted into credits at any time by hitting a specially designated “harvest” button on the gaming machine. Players can decide to harvest crops for an immediate credit reward, or can hold off in hopes of a larger future reward. As such, the “Money Farm” risk proposition can be similar to the aspect of “letting your bets ride” in craps.

FIG. 8B provides an exemplary series of primary game reel symbols and secondary game sub-symbols for the “Money Farm” themed secondary game according to various embodiments of the present invention. Various primary game reel symbols 214 are shown as the K, Q, J and A symbols respectively. Secondary game sub-symbols can include, for example, a sun symbol 215 that multiplies crops, a payday symbol 216 that pays dividends on crops, an insect symbol 217 that kills or depletes crops, and a blue ribbon symbol 218 that can instigate a bonus round or a communal event that applies to a whole bank of gaming machines. In addition, one or more rain symbols 219 can result in crops growing extra fast for that player or a whole bank of players near the machine where the rain symbol(s) are hit.

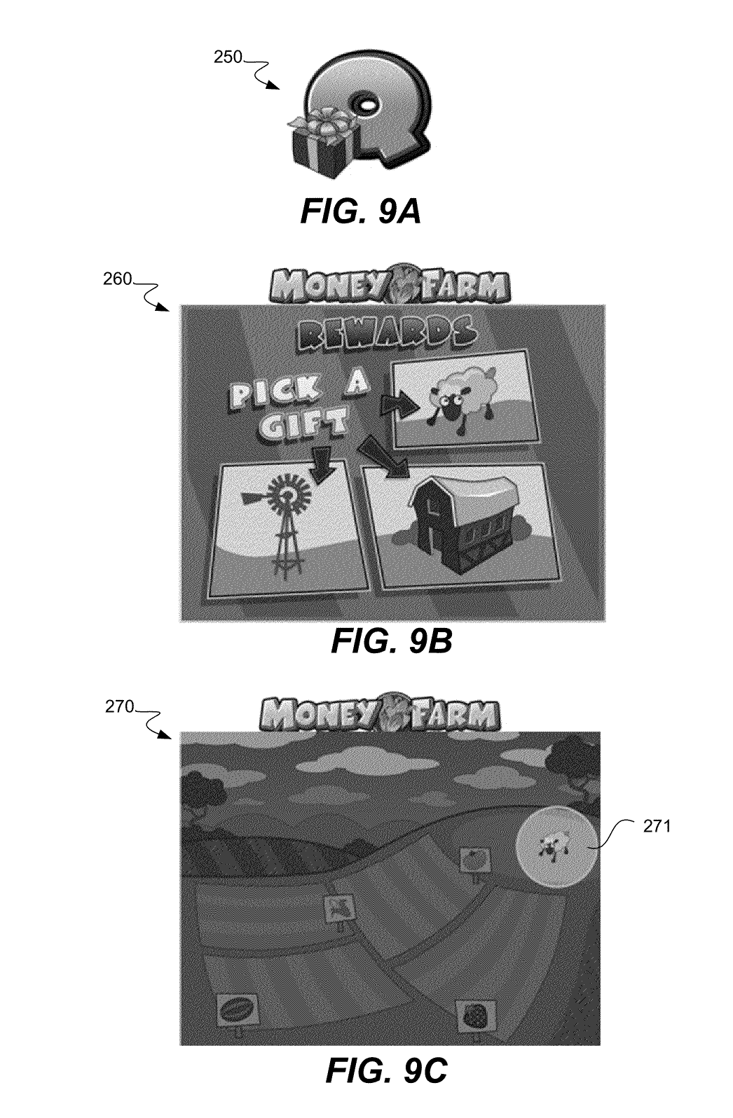

FIG. 9A provides an exemplary primary game reel symbol and secondary game “gifting” sub-symbol as yet another example of how a farm game might work. Combination reel symbol Q and gift 250 can result in the affected player being able to gift a vanity item to another player on the persistent secondary game platform. Such a gift might be selected from a menu of gifts, for example. FIG. 9B provides an exemplary screenshot 260 of one possible choice of gifts for the persistent secondary game having a “Money Farm” theme. Such possible gifts or vanity items can include, for example, a sheep or other animal, a windmill or other structure, and/or a barn or other farm building. Of course, numerous other examples are also possible.

FIG. 9C provides another screenshot 270 of the exemplary persistent secondary game “Money Farm” environment of FIG. 7A after a selected gift 271 from the choices in FIG. 9B has been given and placed. Such a gift can be in the form of the sheep 271 as shown, and this item can be provided to another player as a social gaming type of activity. After one player gifts an item to another player, the other player can then be presented with this “gift” immediately if he or she is playing on another machine at that time or upon the next check in by that player at a “Money Farm” gaming machine.

As yet another possibility, such gifts and/or other controls with respect to the configurations of their individual farms can be made available to players at other venues that do not necessarily involve the play of primary games. For example, one or more Internet websites can host displays of the various secondary farms built by players over their gaming experiences. Such displays can be provided for players and their families or friends to view or share on the Internet at times when the players are not actually participating in primary games. Various configurations, placements and rearrangement of farm items, vanity items and other items can be accomplished during such down times, although such activities may not involve the placement of wagers or awarding or payment of monetary amounts. To this extent, one or more communication interfaces can be provided on the various gaming machines or systems to facilitate the provision of data to such outside websites or hosts.

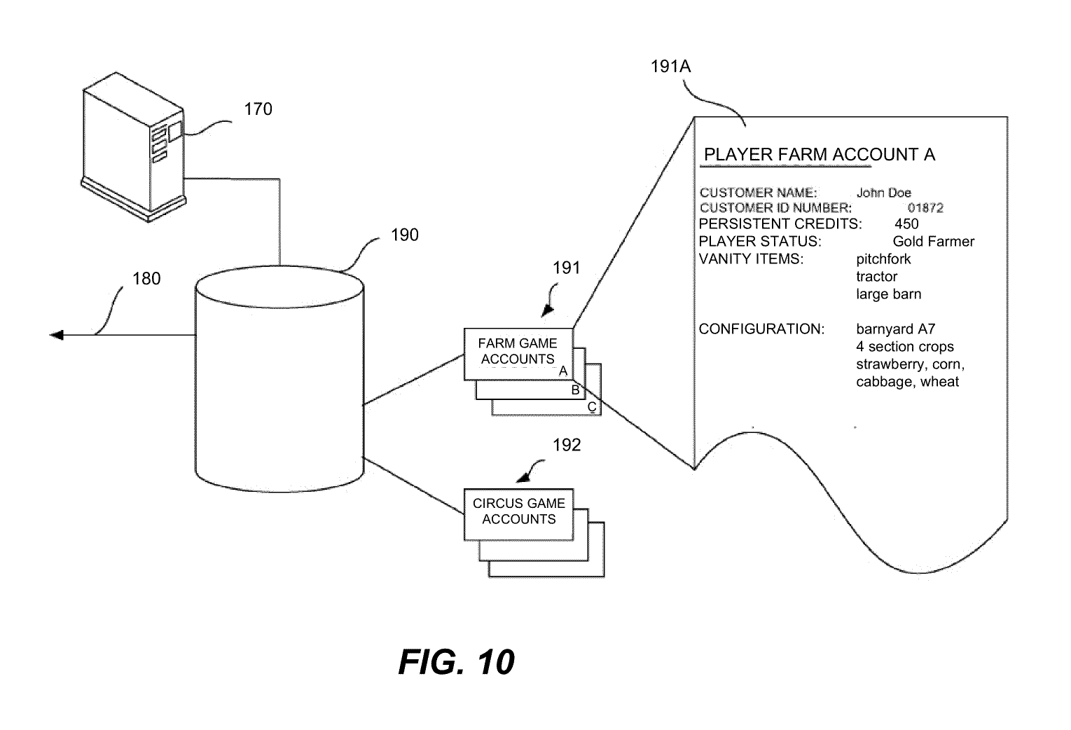

Turning now to FIG. 10, an exemplary persistent secondary game player profile according to one embodiment of the present invention is disclosed. Again, a special purpose server 170 adapted for providing or administering a persistent secondary game across multiple gaming machines can be coupled to a specialized secondary game database 190, which can be coupled to one or more other system or network components via bus 180. This database 190 can hold a plurality of player accounts 191 with respect to a first secondary game, such as a farm themed game, as well as a plurality of player accounts 192 with respect to an alternative or separate secondary game, such as a circus themed game.

In alternative embodiments, each single player profile can contain data for numerous different secondary game themes or progressions. Tracking of player data can be made by way of, for example, the use of player tracking cards or other instruments that can be used to identify players. Such identification can then be used to download or otherwise provide credits, data, configuration and other information particular to an individual player when the player initiates a new gaming session at a machine that features a secondary game that the player has played before.

As shown, exemplary persistent secondary game player profile 191A can contain a variety of information regarding the player and the current status or progression of that player within one or more secondary games. Such information can include, for example, a customer name, customer ID number, an amount of persistent credits owned or attributed to the player, a player status, one or more vanity items or gifts owned or attributed to the player, and one or more configurations that the player has earned or selected through the course of playing the secondary game.

Again, various possible examples of vanity items or gifts for a “Money Farm” themed persistent secondary game can include barns, tractors, windmills, pitchforks, hay bales, specific animals, specific characters, special crops and the like. Various examples of player earned or selected customized farm configurations can include the number, size, shape and locations of various crops, farm buildings, farm vehicles, farm animals, characters and the like. Of course, such vanity items, gifts, and customized configurations can be varied as may be suitable for different themed games, such as, for example, a circus, a city, a zoo, a military, an auto race, a sporting event, an adventure and a treasure hunt, among numerous other possibilities.

### Methods

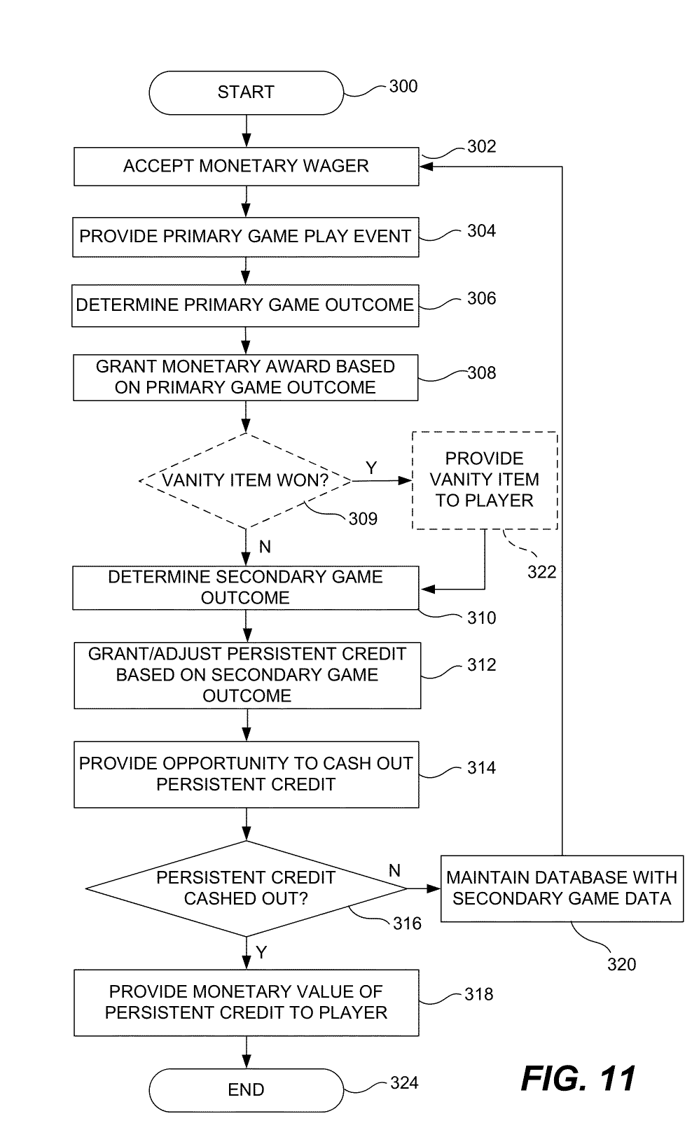

Lastly, FIG. 11 provides a flowchart of an exemplary method of providing a persistent secondary game associated with primary games that involve monetary wagers according to one embodiment of the present invention. It will be understood that the provided steps are shown only for purposes of illustration, and that many other or different steps may be included in the process, as may be desired. Furthermore, the order of steps may be changed where appropriate and not all steps need be performed in various instances. For example, the order of steps 304 and 306 may be reversed, while optional step 322 may be performed at several different points in the process. Other differences may also be possible, and it will be readily appreciated that the described steps and order are not limiting in any way.

After a start step 300, an initial process step 302 involves accepting a monetary wager from a player. Such a monetary wager can be made by inputting cash or credit, or by authorizing a wager from existing credit, for example, at an electronic gaming machine. At a subsequent process step 304, a primary game play event is presented at a display screen or otherwise provided to the player, after which a primary game outcome can be determined at process step 306. Again, the primary game outcome may be determined prior to the presentation of the primary game to the player, as will be readily appreciated. A monetary award or payout based upon the outcome of the primary game can then be granted to the player at process step 308. Of course, not all primary game plays will result in the grant of a monetary award or payout, although some will.

A secondary game outcome can be determined at process step 310. As noted above, the order of steps here is not critical, such that the determination of a secondary game outcome can happen concurrently with or prior to any of steps 304 through 308. At process step 312, a persistent credit can be granted or adjusted based upon the secondary game outcome. Such a credit might be considered a “grant” where the player has no persistent credit balance, and would then be an adjustment up or down where the player made the initial wager at 302 already having a persistent credit balance.

At subsequent process step 314, the player can then be provided an opportunity to cash out or otherwise redeem the persistent credit balance or at least a portion thereof. Such an opportunity may be passive in nature, such that no action prior to making another primary game wager or action results in any secondary persistent credit cash out. Also, the player may elect to cash out only a portion of his or her persistent credit balance. Again, such an opportunity to cash out might also be active, such as in the form of a “banker” or other agent notifying the player of the cash out ability, or even offering more than what the balance value is worth to cash out or take another specific action at that time only. Such other actions may also be promotional in nature, such as in accepting reservations or tickets to a restaurant, show or hotel at or in association with the hosting gaming establishment. In yet another embodiment, the player may only be able to redeem or utilize their persistent credits after an in-game event has occurred and in response to the in-game event.

At subsequent decision step 316, an inquiry is made as to whether the player has elected to cash out his or her persistent credit balance. If not, then the method moves to process step 320, where a database having secondary game data is maintained or updated with new data regarding the updated balance and/or progress of the player in the persistent secondary game environment. An optional step 322 can also be observed, such as where a gift, vanity item, or status is earned or provided to the player.

In one embodiment, in 309, a determination is made in regards to awarding a vanity item. When a determination is made to award the vanity item in 309, the vanity item is provided to the player in 322. The decision in 309 occurs between 308 and 310. Again, such an optional step can be provided anywhere in the disclosed method, as may be appropriate. In addition, the determination to award vanity can be made multiple times, such as between steps 308 and 310 and then again after step 312. Preferably, the presence of such a new gift, vanity item or status is also updated to the player account at the maintained database for the persistent secondary game.

In other embodiments, a virtual vanity item or status can be awarded as part of a primary game or a secondary game. For example, during a play of a primary reel-based game, an award of a virtual vanity item or status can be indicated when an appearance of an extra symbol, such as an extra symbol appearing with the symbols normally used to reveal an outcome to the primary-reel based game. In another example, a deposit of a certain amount of money can result in an award of a virtual vanity item or status. In yet another example, the act of wagering a certain amount on one or more games can result in an award of a virtual vanity item or status. In this example, the award can occur prior to the game even being initiated by the player.

In a further example, if a player has played for a certain length of time, has won a certain amount during a game play session or has lost a certain amount during a game play session, the player, at the time cash-out request is received or credits have reached zero on the gaming machine, can be awarded a virtual vanity item or status. As described above, as a result of an event, a particular virtual vanity item or status can be awarded to the player. In another embodiment, as a result of an event, an award of a virtual vanity item or status can involve allowing a player to select one or more items a from a list of virtual vanity items or statuses that are available for the award where the player is awarded the selected items.

In yet other embodiments, virtual vanity items or status can be awarded based the play of games not involving wagers of cash or cash equivalents. For example, a player can wager player tracking points or other some other type of loyalty point to win virtual vanity items or statuses. In yet another embodiment, a player may play a social media based game to earn virtual vanity items or status where the virtual vanity items or statuses can be transferred to a casino-type gaming machine to effect the game play on the machine.

In various embodiments, it will be appreciated that maintaining or updating the database may take place less frequently than between every primary game play. For example, such an updating might take place at periodic intervals during a gaming session, and/or at the end of a given gaming session. In such instances, an ongoing updated status of the persistent credit level and any updated or new vanity items, statuses, gifts or configurations can be maintained locally at the individual gaming machine where the gaming session is taking place.

Moving back to decision step 316, where the answer is yes, then the method continues to process step 318. At this step 318, the monetary value of the persistent credit balance is paid out to the player, the balance is zeroed out, and the method then ends at end step 324.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

1. A processor-based gaming machine adapted for accepting monetary wagers, playing primary games based on the wagers and granting payouts based on the result of the wager-based primary games, the gaming machine comprising:
an exterior housing arranged to contain a plurality of internal gaming machine components therein;
a master gaming controller in communication with at least one of said plurality of internal gaming machine components and configured to present a wager-based primary game to a player, wherein the primary wager-based game includes discrete game events that each include a discrete wager and a final resolution to the discrete wager based on an outcome of each discrete game event;
a display device in communication with said master gaming controller and adapted to present one or more aspects of said wager-based primary games thereupon; and
a secondary game component in communication with said master gaming controller and adapted to execute or control one or more aspects of a secondary game that is associated with said wager-based primary game, wherein said secondary game enables the player to accumulate persisting credits, wherein each persisting credit has a standard monetary value that remains across the play of multiple discrete primary games, wherein an amount of persisting credits accumulated by the player varies during game play of the wager-based primary game, wherein the player can cash out each accumulated persisting credit for the standard monetary value, and wherein said secondary game includes periodic offers to the player to cash out at least a portion of the amount of persisting credits accumulated by the player at a value higher than the standard monetary value.

2. The processor-based gaming machine of claim 1, wherein at least a portion of said secondary game component is included within said master gaming controller.

3. The processor-based gaming machine of claim 1, wherein at least a portion of said secondary game component is included at a server in communication with and located remotely from said processor-based gaming machine.

4. The processor-based gaming machine of claim 1, wherein said persisting credits have a value that can rise, fall, or remain constant based on the play of a discrete primary game.

5. The processor-based gaming machine of claim 1, wherein said persisting credits can be cashed out by a player at any time.

6. The processor-based gaming machine of claim 1, wherein said primary game comprises a reel based game that uses reel symbols to indicate the outcome of the primary game.

7. The processor-based gaming machine of claim 6, wherein said secondary game uses sub-symbols on the primary game reels to indicate the progression of the secondary game.

8. (canceled)

9. The processor-based gaming machine of claim 1, wherein said secondary game comprises a themed game.

10. The processor-based gaming machine of claim 9, wherein each player is permitted to develop and maintain a virtual entity based upon said theme.

11. The processor-based gaming machine of claim 9, wherein said theme is selected from the group consisting of: a farm, a circus, a city, a zoo, a military, an auto race, a sporting event, an adventure and a treasure hunt.

12. The processor-based gaming machine of claim 1, wherein said secondary game further includes a grant of virtual vanity items or statuses for players.

13. The processor-based gaming machine of claim 12, wherein said virtual vanity items or statuses can be obtained by players through the use of said persisting credits.

14. The processor-based gaming machine of claim 12, wherein said virtual vanity items or statuses can persist for players across separate gaming sessions.

15. The processor-based gaming machine of claim 1, wherein one or more primary indicators indicate the outcome of said primary games, and wherein one or more separate secondary indicators indicate the result or progression of said secondary game.

16. The processor-based gaming machine of claim 1, further including: a communication interface adapted to communicate with and to provide information regarding said secondary game to one or more outside devices, and
wherein said provided secondary game information is made available to players on a separate social gaming venue.

17. A method of providing a persistent secondary game associated with primary games that involve monetary wagers, the method comprising:
accepting a first monetary wager from a player at a gaming machine; providing a first primary game play event at the gaming machine based upon the first monetary wager;
determining a first primary game outcome based upon the first primary game play event;
granting a first monetary award to the player based upon the first primary game outcome;
determining an initial secondary game outcome in association with the first primary game play event, wherein said initial secondary game outcome does not require any additional monetary wager from the player;
granting a persistent credit having a monetary value to the player based upon the initial secondary game outcome, wherein the persistent credit has a displayed value;
providing an opportunity to the player to redeem said persistent credit prior to the play of a second primary game play event for the displayed value;
accepting a second monetary wager from the player;
providing the second primary game play event based upon the second monetary wager, said second primary game play event being separate and discrete from said first primary game play event, wherein said second primary game play event is provided after the player has elected not to redeem said persistent credit;
determining a second primary game outcome based upon the second primary game play event;
granting a second monetary payout to the player based upon the second primary game outcome;
determining a subsequent secondary game outcome in association with the second primary game play event, wherein said subsequent secondary game outcome does not require any additional monetary wager from the player;
adjusting the displayed value of said persistent credit based upon the subsequent secondary game outcome; and
presenting an offer to the player to cash out the persistent credit at a value greater than the displayed value.

18. The method of claim 17, wherein said step of adjusting results in the value of said persistent credit being decreased.

19. The method of claim 17, further comprising the step of:
maintaining a database of stored player profiles that include individual player data regarding said secondary game.

20. The method of claim 17, wherein said step of adjusting results in the value of said persistent credit being increased.

21. A gaming system adapted to provide persistent secondary games associated with primary games that involve monetary wagers, comprising:
a plurality of gaming machines, each having a master gaming controller adapted to execute or control one or more aspects of said wager-based primary games and a secondary game component in communication with said master gaming
controller and adapted to execute or control one or more aspects of a secondary game that is associated with said wager-based primary games, wherein said secondary game includes the use of persisting credits having a displayed monetary value that remain across the play of multiple discrete primary games, and wherein the controller is configured to present periodic offers to the player to cash in the persisting credits for a value that is greater than the displayed monetary value;
a database storing a plurality of player profiles that include individual player data regarding said secondary game; and
a remote secondary game server in communication with the plurality of gaming machines and the database, said remote secondary game server including a processor, a memory and a network interface, wherein the processor is configured to:
receive information regarding gaming activity by a player from said one of the plurality of gaming machines,
determine whether the player is associated with an existing player profile stored on the database,
provide data to the gaming machine regarding a customized status of a secondary game for the player when it is determined that the received information is associated with an existing player profile stored on the database, and
update the existing player profile based upon gaming activity at the gaming machine when it is determined that the received information is associated with an existing player profile stored on the database.

22. A non-transitory computer readable medium including instructions executed by a processor to generate a wager-based game, the computer readable medium comprising:
computer code for accepting a first monetary wager from a player at a gaming machine;
computer code for providing a first primary game play event at the gaming machine based upon the first monetary wager;
computer code for presenting a first primary game outcome based upon the first primary game play event;
computer code for granting a first monetary award to the player based upon the first primary game outcome;
computer code for presenting an initial secondary game outcome in association with the first primary game play event, wherein said initial secondary game outcome does not require any additional monetary wager from the player;
computer code for presenting a grant of a persistent credit having a monetary value to the player based upon the initial secondary game outcome, wherein the persistent credit has a displayed value;
computer code for providing an opportunity to the player to redeem said persistent credit prior to the play of a second primary game play event, for the displayed value;
computer code for accepting a second monetary wager from the player;
computer code for providing the second primary game play event based upon the second monetary wager, said second primary game play event being separate and discrete from said first primary game play event, wherein said second primary game play event is provided after the player has elected not to redeem said persistent credit;
computer code for presenting a second primary game outcome based upon the second primary game play event;
computer code for presenting a grant a second monetary payout to the player based upon the second primary game outcome;
computer code presenting a subsequent secondary game outcome in association with the second primary game play event, wherein said subsequent secondary game outcome does not require any additional monetary wager from the player;
computer code for adjusting the displayed value of said persistent credit based upon the subsequent secondary game outcome; and
computer code for presenting an offer to the player to cash out the persistent credit at a value greater than the displayed value.

23. The computer readable medium of claim 22, wherein the gaming machine is a user-controlled device.

24. The computer readable medium of claim 23, wherein the user-controlled device is a mobile device.

25. The computer readable medium of claim 22, further comprising computer code for receiving from a remote device one or more of the first primary game outcome, an initial secondary game outcome, an initial secondary game outcome, a second primary game outcome, a subsequent secondary game outcome or combinations thereof.

26. The computer readable medium of claim 22, further comprising computer code for determining on the gaming machine one or more of the first primary game outcome, an initial secondary game outcome, an initial secondary game outcome, a second primary game outcome, a subsequent secondary game outcome or combinations thereof.

27. The computer readable medium of claim 22, further comprising computer code for presenting a grant of virtual vanity items or statuses.

28. The computer readable medium of claim 27, wherein the virtual vanity items or statuses are granted during play of a primary game or a secondary game.

29. The computer readable medium of claim 27, wherein a previous grant of the virtual vanity items or the statuses increases chances of triggering a future bonus.

30. The computer readable medium of claim 27, wherein a previous grant of the virtual vanity items or the statuses increases an expected value of a future bonus.

31. The computer readable medium of claim 22, wherein the persistent credit is only redeemable as a result of an in-game event.

32. The processor-based gaming machine of claim 1, wherein the primary wager-based game is a slot game, wherein the slot game includes a plurality of slot reels used to determine the outcome of each discrete game event and an independent reel used to determine an aspect of the secondary game.
